(19) United States
(12) Patent Application Publication
(10) Pub. No.: US 2019/0332892 A1
(43) Pub. Date: Oct. 31, 2019

(54) DATA INTELLIGENCE DRIVEN ARTIFICIAL INTELLIGENCE MODEL GENERATION AND CONSUMPTION

(71) Applicant: General Electric Company, Schenectady, NY (US)

(72) Inventor: Matthew Wickesberg, New Berlin, WI (US)

(21) Appl. No.: 15/962,497

(22) Filed: Apr. 25, 2018

(51) Int. Cl. G06K 9/62; G06F 15/18; G06F 17/30

(52) U.S. Cl. CPC G06K 9/6253; G06F 15/18; G06F 17/30592; G06K 9/6278; G06F 17/30572; G06K 9/6263

(57) ABSTRACT

Systems and techniques for facilitating data intelligence driven artificial intelligence model generation and consumption are presented. In one example, a system includes a data intelligence component, a prediction component and a machine learning component. The data intelligence component analyzes data associated with a data visualization tool to determine a subset of the data to model. The prediction component generates prediction target data indicative of a set of prediction goals associated with the data based on a set of user interactions associated with the data visualization tool. The machine learning component generates a machine learning model for the data based on the subset of the data and the prediction target data.

### TECHNICAL FIELD

This disclosure relates generally to data intelligence and artificial intelligence.

### BACKGROUND

Artificial Intelligence (AI) generally involves complex analysis of data to obtain, for example, classifications and/or inferences associated with the data. For example, an AI process can include symbolic analysis of data, deep learning with respect to data, probabilistic modeling of data, computational intelligence with respect to data, machine learning with respect to data, and/or other analysis of data. Furthermore, leveraging AI models can be similarly complex. As such, it is desirable to reduce complexity to generate an AI model and/or to reduce complexity to consume an AI model.

### SUMMARY

The following presents a simplified summary of the specification in order to provide a basic understanding of some aspects of the specification. This summary is not an extensive overview of the specification. It is intended to neither identify key or critical elements of the specification, nor delineate any scope of the particular implementations of the specification or any scope of the claims. Its sole purpose is to present some concepts of the specification in a simplified form as a prelude to the more detailed description that is presented later.

According to an embodiment, a system includes a data intelligence component, a prediction component and a machine learning component. The data intelligence component analyzes data associated with a data visualization tool to determine a subset of the data to model. The prediction component generates prediction target data indicative of a set of prediction goals associated with the data based on a set of user interactions associated with the data visualization tool. The machine learning component generates a machine learning model for the data based on the subset of the data and the prediction target data.

According to another embodiment, a method is provided. The method provides for analyzing, by a system comprising a processor, data associated with a data visualization tool to determine a subset of the data for a machine learning process. Furthermore, the method provides for generating, by the system, prediction target data indicative of a set of prediction goals associated with the data based on a set of user interactions associated with the data visualization tool. The method also provides for performing, by the system, the machine learning process to generate a machine learning model for the data based on the subset of the data and the prediction target data.

According to yet another embodiment, a computer readable storage device is provided. The computer readable storage device comprises instructions that, in response to execution, cause a system comprising a processor to perform operations, comprising: analyzing data associated with a data visualization tool to determine a subset of the data to model, generating prediction target data indicative of a set of prediction goals associated with the data based on a set of user interactions associated with the data visualization tool, generating a machine learning model for the data based on the subset of the data and the prediction target data, and displaying the machine learning model in a graphical human interpretable format.

The following description and the annexed drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, implementations, objects and advantages of the present invention will be apparent upon consideration of the following detailed description, taken in conjunction with the accompanying drawings, in which like reference characters refer to like parts throughout, and in which:

FIG. 1 illustrates a block diagram of an example, non-limiting system associated with a data analytics component in accordance with one or more embodiments described herein;

FIG. 2 illustrates a block diagram of another example, non-limiting system associated with a data analytics component in accordance with one or more embodiments described herein;

FIG. 3 illustrates a block diagram of an example, non-limiting system associated with data intelligence driven artificial intelligence in accordance with one or more embodiments described herein;

FIG. 4 illustrates an example, non-limiting system associated with a subset of data and reformatted data in accordance with one or more embodiments described herein;

FIG. 5 illustrates an example, non-limiting system associated with a data visualization tool in accordance with one or more embodiments described herein;

FIG. 6 illustrates an example, non-limiting system associated with a user interface in accordance with one or more embodiments described herein;

FIG. 7 depicts a flow diagram of an example method for facilitating data intelligence driven artificial intelligence, in accordance with one or more embodiments described herein;

FIG. 8 depicts a flow diagram of an example method for facilitating data intelligence driven artificial intelligence, in accordance with one or more embodiments described herein;

FIG. 9 is a schematic block diagram illustrating a suitable operating environment; and

FIG. 10 is a schematic block diagram of a sample-computing environment.

### DETAILED DESCRIPTION

Various aspects of this disclosure are now described with reference to the drawings, wherein like reference numerals are used to refer to like elements throughout. In the following description, for purposes of explanation, numerous specific details are set forth in order to provide a thorough understanding of one or more aspects. It should be understood, however, that certain aspects of this disclosure may be practiced without these specific details, or with other methods, components, materials, etc. In other instances, well-known structures and devices are shown in block diagram form to facilitate describing one or more aspects.

Systems and techniques for facilitating data intelligence driven artificial intelligence model generation and/or consumption are presented. For example, as compared to conventional artificial intelligence techniques, the subject innovations provide for a novel artificial intelligence framework that leverages data intelligence technologies as an intermediary to facilitate automated artificial intelligence model generation. Additionally or alternatively, the generated artificial intelligence models can be consumed seamlessly through an intermediary data intelligence layer. In an aspect, data science can be injected into a data visualization tool to facilitate artificial intelligence model generation and/or consumption. In an embodiment, an artificial intelligence engine, data intelligence tools and an artificial intelligence orchestration engine can be integrated together to facilitate artificial intelligence model generation and/or consumption. One or more prediction goals for a machine learning model can also be presented via a data visualization tool in a graphical manner. For instance, the data visualization tool can be employed to ask one or more questions dynamically for an artificial intelligence tool. In another embodiment, data intelligence can be leveraged as a tool to automate interaction with an artificial intelligence orchestration engine. As such, an amount of time to create and/or test a machine learning model can be reduced. Also, a user without artificial intelligence knowledge can develop predictive analytics by employing the novel artificial intelligence framework disclosed herein. In addition, accuracy of data generated by a machine learning process can be improved, quality of a machine learning process can be improved, speed of data generated by a machine learning process can be improved, and/or a cost for analyzing data using a machine learning process can be reduced. Moreover, accuracy and/or efficiency of a machine learning model generated by a machine learning process can be provided. Furthermore, complexity to generate an artificial intelligence model and/or to consume an artificial intelligence model can be reduced.

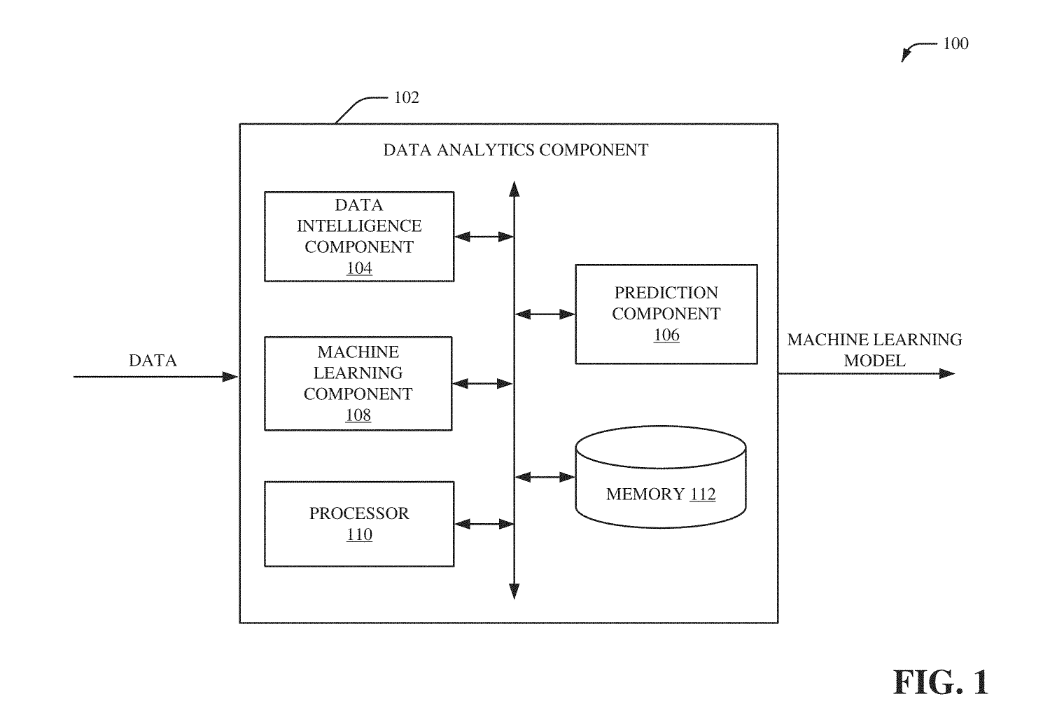

Referring initially to FIG. 1, there is illustrated an example system 100 that provides data intelligence driven artificial intelligence model generation and/or consumption, according to an aspect of the subject disclosure. The system 100 can be employed by various systems, such as, but not limited to medical device systems, medical imaging systems, medical diagnostic systems, medical systems, medical modeling systems, enterprise imaging solution systems, advanced diagnostic tool systems, simulation systems, image management platform systems, care delivery management systems, artificial intelligence systems, machine learning systems, neural network systems, data intelligence systems, modeling systems, aviation systems, power systems, distributed power systems, energy management systems, thermal management systems, transportation systems, oil and gas systems, mechanical systems, machine systems, device systems, cloud-based systems, heating systems, HVAC systems, medical systems, automobile systems, aircraft systems, water craft systems, water filtration systems, cooling systems, pump systems, engine systems, prognostics systems, machine design systems, and the like. In a non-limiting example, the system 100 can be associated with a viewer system to facilitate visualization and/or interpretation of medical data. Moreover, the system 100 and/or the components of the system 100 can be employed to use hardware and/or software to solve problems that are highly technical in nature (e.g., related to processing digital data, related to artificial intelligence, etc.), that are not abstract and that cannot be performed as a set of mental acts by a human.

The system 100 can include a data analytics component 102 that can include a data intelligence component 104, a prediction component 106 and a machine learning component 108. Aspects of the systems, apparatuses or processes explained in this disclosure can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described. The system 100 (e.g., the data analytics component 102) can include memory 112 for storing computer executable components and instructions. The system 100 (e.g., the data analytics component 102) can further include a processor 110 to facilitate operation of the instructions (e.g., computer executable components and instructions) by the system 100 (e.g., the data analytics component 102).

The data analytics component 102 (e.g., the data intelligence component 104) can receive data (e.g., DATA shown in FIG. 1). The data can be generated by one or devices. Additionally or alternatively, the data can be stored in one or more databases that receives and/or stores the data associated with the one or devices. For example, the data can be generated by and/or associated with one or more assets, one or more types of devices, one or more types of machines and/or one or more types of equipment. The one or more databases can be located, for example, at one or more locations (e.g., one or more geographic locations). In an aspect, the data can be digital data. Furthermore, the data can include various data, such as but not limited to, medical data, medical imaging data, sensor data, process data (e.g., process log data), operational data, monitoring data, maintenance data, parameter data, measurement data, performance data, audio data, image data, video data, industrial data, machine data, asset data, equipment data, device data, meter data, real-time data, historical data and/or other data. The data can also be encoded data, processed data and/or raw data. Additionally, the stored data can be associated with one or more systems such as, but not limited to one or more healthcare systems, one or more industrial systems, one or more aviation systems, one or more manufacturing systems, one or more factory systems, one or more energy management systems, one or more power grid systems, one or more water supply systems, one or more transportation systems, one or more refinery systems, one or more media systems, one or more financial systems, one or more research systems, one or more PaaS systems, one or more asset performance management systems, one or more other enterprise systems, and/or one or more other technical systems. In a non-limiting embodiment, the data can be medical data. For instance, the data can be two-dimensional medical data and/or three-dimensional medical data generated by one or more medical devices. In one example, the data can be electromagnetic radiation imagery captured via a set of sensors (e.g., a set of sensors associated with a medical device). In certain embodiments, the data can be a series of electromagnetic radiation imagery captured via a set of sensors (e.g., a set of sensors associated with a medical device) during an interval of time. A medical device can be, for example, an x-ray device, a computed tomography (CT) device, another type of medical device, etc.

In an embodiment, the data can be associated with a data visualization tool. The data visualization tool can render the data in a human interpretable format on a display of a user device. The user device can be, for example, a computing device, a computer, a desktop computer, a laptop computer, a monitor device, a smart device, a smart phone, a mobile device, a handheld device, a tablet, a portable computing device or another type of user device associated with a display. In an aspect, the data visualization tool can be a user interface (e.g., a graphical user interface) associated with the user device. In another aspect, the data visualization tool can allow a user to view, analyze and/or interact with the data. In yet another aspect, the data visualization tool can be a dashboard (e.g., a data intelligence dashboard) that provides metrics associated with the data and/or key performance indicators associated with the data.

The data intelligence component 104 can analyze the data associated with the data visualization tool. In an aspect, the data intelligence component 104 can analyze the data associated with the data visualization tool to determine a subset of the data to model. For instance, the data intelligence component 104 can analyze the data associated with the data visualization tool to determine a subset of the data that can be employed to generate a machine learning model. The subset of the data can also be a subset of the data that can undergo a learning process to determine one or more predictions associated with the subset of the data. In an embodiment, the data intelligence component 104 can perform a data scrubbing process associated with the data to determine the subset of the data. For example, the data scrubbing process can include decoding the data, filtering the data, processing the data, combining the data and/or translating the data. As such, at least a portion of the subset of the data can include decoded data, filtered data, processed data, combined data and/or translated data. In certain embodiments, the data intelligence component 104 can reformat the subset of the data into reformatted data. For example, the data intelligence component 104 can employ a multi-dimensional database to transform the subset of the data into reformatted data. Additionally, in certain embodiments, the data intelligence component 104 can provide the reformatted data to one or more machine learning process (e.g., one or more machine learning process associated with the machine learning component 108).

The prediction component 106 can generate prediction target data based on a set of user interactions associated with the data visualization tool. The prediction target data can be indicative of a set of prediction goals (e.g., a set of prediction targets) associated with the data. The set of user interaction can be a set of user interactions to, for example, view, analyze and/or interact with the data via the data visualization tool. In an aspect, the set of user interaction can be a set of workflows to dynamically create the prediction target data. In an embodiment, the prediction component 106 can generate the prediction target data based on a set of graphical questions associated with the data visualization tool. For instance, the data visualization tool can present a set of questions graphically and the prediction component 106 can generate the prediction target data based on analysis of a set of user interactions associated with the set of questions. The set of graphical questions can, for example, ask how to perform a prediction, provide a menu of how to perform a prediction, etc.

The machine learning component 108 can generate a machine learning model for the data based on the subset of the data and/or the prediction target data. For example, the data intelligence component 104 can send the subset of the data to the machine learning component 108. Additionally or alternatively, the prediction component 106 can send the prediction target data to the machine learning component 108. Based on the subset of the data from the data intelligence component 104 and/or the prediction target data from the prediction component 106, the machine learning component 108 can generate one or more machine learning model for the data. In certain embodiments, the machine learning component 108 can generate two or more machine learning models for the data. For example, the data intelligence component can provide the portion of the data and/or the prediction target data to a first machine learning process and at least a second machine learning process that is executed in parallel to the first machine learning process. In another example, the data intelligence component can provide the reformatted data and/or the prediction target data to a first machine learning process and at least a second machine learning process that is executed in parallel to the first machine learning process.

In an embodiment, the machine learning component 108 can perform a machine learning process (e.g., an artificial intelligence process for machine learning) based on the subset of the data and/or the prediction target data. In an aspect, the machine learning component 108 can perform deep learning to facilitate one or more classifications, one or more inferences and/or one or more predictions associated with the data. For instance, the machine learning component 108 can extract information that is indicative of correlations, inferences and/or expressions from the subset of the data and/or the prediction target data. Furthermore, the machine learning component 108 can generate a machine learning model (e.g., MACHINE LEARNING MODEL shown in FIG. 1) based on the subset of the data and/or the prediction target data. The machine learning model generated by the machine learning component 108 can include, for example, learning, correlations, inferences and/or expressions associated with the data. In an aspect, the machine learning component 108 can perform learning with respect to the data and/or the prediction target data explicitly or implicitly using the subset of the data and/or the prediction target data. The machine learning component 108 can also employ an automatic classification system and/or an automatic classification process to facilitate analysis of the subset of the data and/or the prediction target data. For example, the machine learning component 108 can employ a probabilistic and/or statistical-based analysis (e.g., factoring into the analysis utilities and costs) to learn and/or generate inferences with respect to the subset of the data and/or the prediction target data. The machine learning component 108 can employ, for example, a support vector machine (SVM) classifier to learn and/or generate inferences for the subset of the data and/or the prediction target data. Additionally or alternatively, the machine learning component 108 can employ other classification techniques associated with Bayesian networks, decision trees and/or probabilistic classification models. Classifiers employed by the machine learning component 108 can be explicitly trained (e.g., via a generic training data) as well as implicitly trained (e.g., via receiving extrinsic information). For example, with respect to SVM's, SVM's can be configured via a learning or training phase within a classifier constructor and feature selection module. A classifier can be a function that maps an input attribute vector, x=(x1, x2, x3, x4, xn), to a confidence that the input belongs to a class—that is, f(x)=confidence(class).

The machine learning component 108 can additionally or alternatively employ any suitable machine-learning based techniques, statistical-based techniques and/or probabilistic-based techniques. For example, the machine learning component 108 can employ expert systems, fuzzy logic, SVMs, Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, etc. In another aspect, the machine learning component 108 can perform a set of machine learning computations associated with learning one or more features and/or information related to the subset of the data and/or the prediction target data. For example, the machine learning component 108 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations to learn one or more features and/or information related to the subset of the data and/or the prediction target data. In certain embodiments, the machine learning component 108 can employ information provided by the machine learning component 108 (e.g., the learned medical imaging output) to classify and/or localize a disease associated with the data. A disease classified and/or localized by the machine learning component 108 can include, for example, a lung disease, a heart disease, a tissue disease, a bone disease, a tumor, a cancer, tuberculosis, cardiomegaly, hypoinflation of a lung, opacity of a lung, hyperdistension, a spine degenerative disease, calcinosis, or another type of disease associated with an anatomical region of a patient body. In an aspect, the machine learning component 108 can determine a prediction for a disease associated with the data.

It is to be appreciated that technical features of the data analytics component 102 are highly technical in nature and not abstract ideas. Processing threads of the data analytics component 102 that process and/or analyze the data, perform one or more machine learning processes, generate a machine learning model, etc. cannot be performed by a human (e.g., are greater than the capability of a single human mind). For example, the amount of the data processed, the speed of processing of the data and/or the data types of the data processed by the data analytics component 102 over a certain period of time can be respectively greater, faster and different than the amount, speed and data type that can be processed by a single human mind over the same period of time. Furthermore, the data processed by the data analytics component 102 can be data generated by sensors of one or more devices. Moreover, the data analytics component 102 can be fully operational towards performing one or more other functions (e.g., fully powered on, fully executed, etc.) while also processing the data.

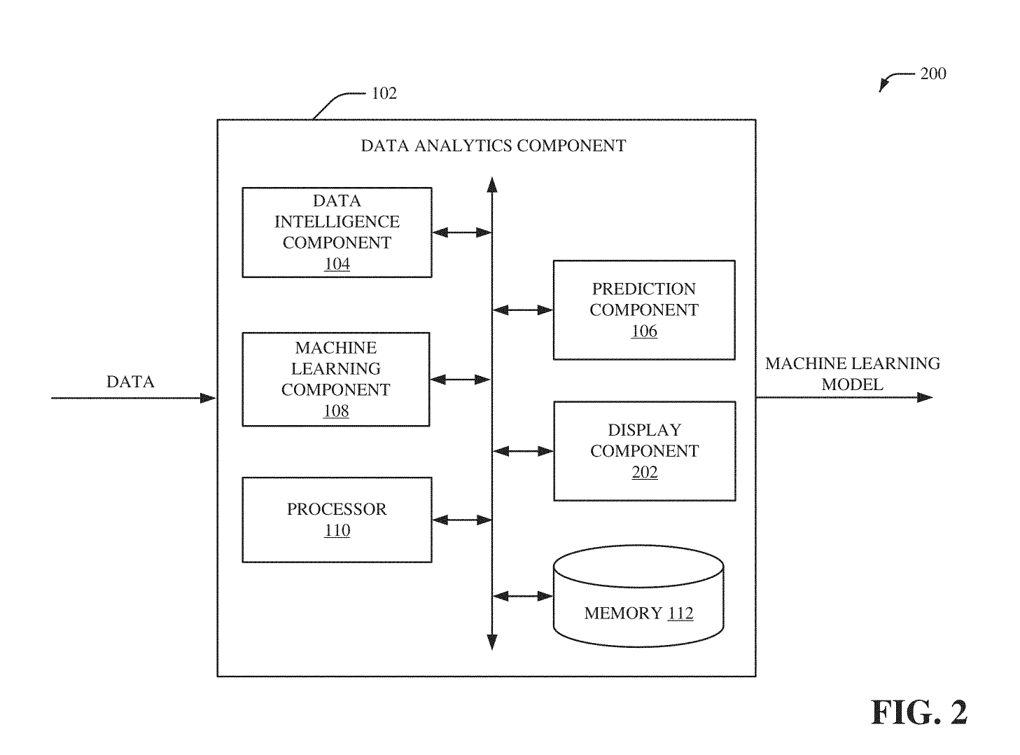

Referring now to FIG. 2, there is illustrated a non-limiting implementation of a system 200 in accordance with various aspects and implementations of this disclosure. Repetitive description of like elements employed in other embodiments described herein is omitted for sake of brevity.

The system 200 can include the data analytics component 102, and the data analytics component 102 can include the data intelligence component 104, the prediction component 106, the machine learning component 108, a display component 202, the processor 110 and/or the memory 112. The display component 202 can generate a user interface (e.g., a graphical user interface) that outputs the machine learning model in a graphical human interpretable format. The user interface can be displayed, for example, on a display of a user device such as a computing device, a computer, a desktop computer, a laptop computer, a monitor device, a smart device, a smart phone, a mobile device, a handheld device, a tablet, a portable computing device or another type of user device associated with a display. In an embodiment, the machine learning model and/or information associated with the machine learning model can be displayed via a data visualization tool. In another embodiment, the user interface that outputs the machine learning model can display metrics and/or key performance indicators related to the machine learning model and/or information associated with the machine learning model. In certain embodiments, the display component 202 can additionally or alternatively generate a user interface (e.g., a graphical user interface) associated with a data visualization tool. The data visualization tool can render data in a human interpretable format on a display of a user device. In an aspect, the data visualization tool can allow a user to view, analyze and/or interact with data. In another aspect, the data visualization tool can be a dashboard (e.g., a data intelligence dashboard) that provides metrics associated with data and/or key performance indicators associated with data.

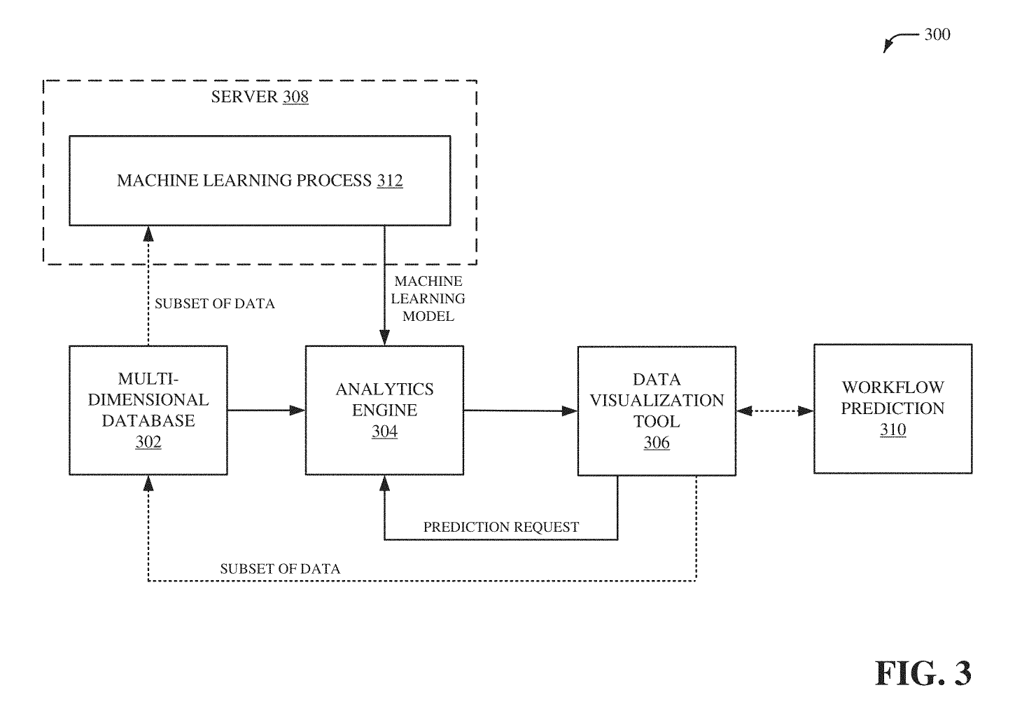

Referring now to FIG. 3, there is illustrated a non-limiting implementation of a system 300 in accordance with various aspects and implementations of this disclosure. Repetitive description of like elements employed in other embodiments described herein is omitted for sake of brevity.

The system 300 can include a multi-dimensional database 302, an analytics engine 304, a data visualization tool 306 and/or a server 308. The multi-dimensional database 302 can store data in a multi-dimensional format. For instance, data stored in the multi-dimensional database 302 can be formatted as a multi-dimensional array of data where data is categorized based on dimensions. In an aspect, data outputted by the multi-dimensional database 302 can be associated with statistics for the subset of data. In another aspect, the multi-dimensional database 302 can store the subset of data in random access memory. In one example, the multi-dimensional database 302 can be an online analytical processing cube. The analytics engine 304 can provide analytics for the data visualization tool 306. The server 308 can execute a machine learning process 312. The machine learning process 312 can include one or more machine learning processes. In an aspect, the analytics engine 304 can provide analytics for the data visualization tool 306 based on information provided by the multi-dimensional database 302 and/or information provided by the machine learning process 312 associated with the server 308.

The data visualization tool 306 can render data provided by the analytics engine 304 and/or the multi-dimensional database 302 in a human interpretable format. In an aspect, the data visualization tool 306 can render data on a display of a user device. The user device can be, for example, a computing device, a computer, a desktop computer, a laptop computer, a monitor device, a smart device, a smart phone, a mobile device, a handheld device, a tablet, a portable computing device or another type of user device associated with a display. The data visualization tool 306 can be a user interface (e.g., a graphical user interface) displayed on the user device. In one example, the data visualization tool 306 can be a dashboard (e.g., a data intelligence dashboard) that provides metrics associated with data and/or key performance indicators associated with data. The data visualization tool 306 can also allow a user to view, analyze and/or interact with data. Data associated with the data visualization tool 306 can include, for example, medical data, medical imaging data, sensor data, process data (e.g., process log data), operational data, monitoring data, maintenance data, parameter data, measurement data, performance data, audio data, image data, video data, industrial data, machine data, asset data, equipment data, device data, meter data, real-time data, historical data and/or other data.

In an embodiment, the data analytics component 102 can be in communication with the data visualization tool 306. The data intelligence component 104 of the data analytics component 102 can analyze data associated with the data visualization tool 306. In an aspect, the data intelligence component 104 can analyze data associated with the data visualization tool 306 to determine a subset of data (e.g., SUBSET OF DATA shown in FIG. 3) associated with the data visualization tool 306. The subset of data determined by the data intelligence component 104 can be stored in the multi-dimensional database 302. Furthermore, the subset of data determined by the data intelligence component 104 can be provided to the machine learning process 312. In an aspect, the data intelligence component 104 can perform a data scrubbing process associated with data visualization tool 306 to determine the subset of data. For example, the data scrubbing process can include decoding data associated with data visualization tool 306, filtering data associated with data visualization tool 306, processing data associated with data visualization tool 306, combining data associated with data visualization tool 306, and/or translating data associated with data visualization tool 306. Furthermore, in certain embodiments, the data intelligence component 104 can reformat the subset of data into reformatted data based on one or more processing criteria associated with the machine learning process 312.

Based on the subset of data determined by the data intelligence component 104, the machine learning process 312 can generate a machine learning model (e.g., MACHINE LEARNING MODEL shown in FIG. 3). In an embodiment, the machine learning process 312 can be associated with an artificial intelligence orchestration engine. The machine learning model can be provided to the analytics engine 304 and/or to the data visualization tool 306. For instance, analytics associated with the machine learning model can be displayed via the data visualization tool 306. In certain embodiments, a workflow prediction 310 can be employed to dynamically create one or more prediction targets with respect to data associated with the data visualization tool 306. In an aspect, the workflow prediction 310 can include one or more workflows that can be graphical and/or launchable via the data visualization tool 306. In an aspect, a prediction request (e.g., PREDICTION REQUEST shown in FIG. 3) associated with the data visualization tool 306 and/or the workflow prediction 310 can be provided to the analytics engine 304. For example, the analytics engine 304 can determine analytics associated with the machine learning model based on the prediction request. In another aspect, the workflow prediction 310 can include prediction target data. The prediction target data can be indicative of a set of prediction goals (e.g., a set of prediction targets) associated with data presented by the data visualization tool 306. In yet another aspect, the workflow prediction 310 (e.g., one or more workflows of the workflow prediction 310) can be associated with a set of user interactions with respect to the data visualization tool 306. The set of user interaction can be a set of user interactions to, for example, view, analyze and/or interact with data via the data visualization tool 306.

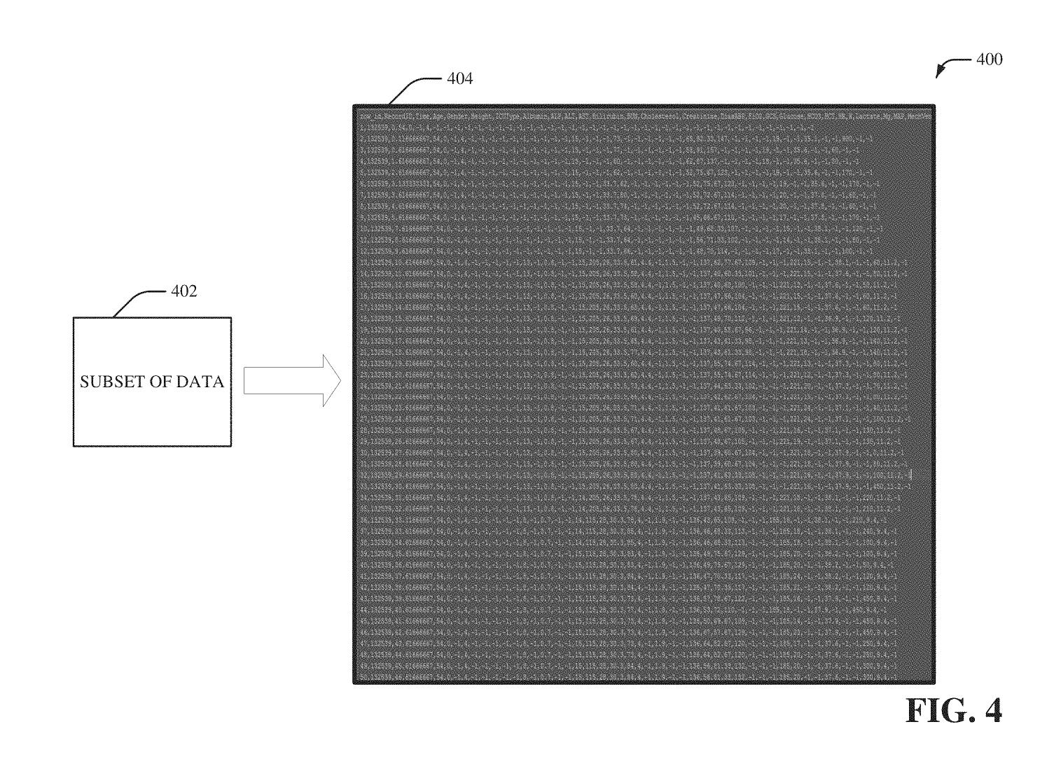

Referring now to FIG. 4, there is illustrated a non-limiting implementation of a system 400 in accordance with various aspects and implementations of this disclosure. Repetitive description of like elements employed in other embodiments described herein is omitted for sake of brevity.

The system 400 includes a subset of data 402 and reformatted data 404. The subset of data 402 can be, for example, data obtained from a data visualization tool (e.g., data visualization tool 306). The subset of data 402 can include, for example, medical data, medical imaging data, sensor data, process data (e.g., process log data), operational data, monitoring data, maintenance data, parameter data, measurement data, performance data, audio data, image data, video data, industrial data, machine data, asset data, equipment data, device data, meter data, real-time data, historical data and/or other data. The subset of data 402 can be reformatted into the reformatted data 404. For example, the data intelligence component 104 can reformat (e.g., transform) the subset of data 402 into the reformatted data 404. In an embodiment, the subset of data 402 can be reformatted (e.g., transformed) into the reformatted data 404 via a multi-dimensional database (e.g., multi-dimensional database 302). The reformatted data 404 can include, for example, a reformatted version of medical data, a reformatted version of medical imaging data, a reformatted version of sensor data, a reformatted version of process data (e.g., a reformatted version of process log data), a reformatted version of operational data, a reformatted version of monitoring data, a reformatted version of maintenance data, a reformatted version of parameter data, a reformatted version of measurement data, a reformatted version of performance data, a reformatted version of audio data, a reformatted version of image data, a reformatted version of video data, a reformatted version of industrial data, a reformatted version of machine data, a reformatted version of asset data, a reformatted version of equipment data, a reformatted version of device data, a reformatted version of meter data, a reformatted version of real-time data, a reformatted version of historical data and/or a reformatted version of other data. In another embodiment, the reformatted data 404 can be provided to one or more machine learning processes (e.g., machine learning process 312).

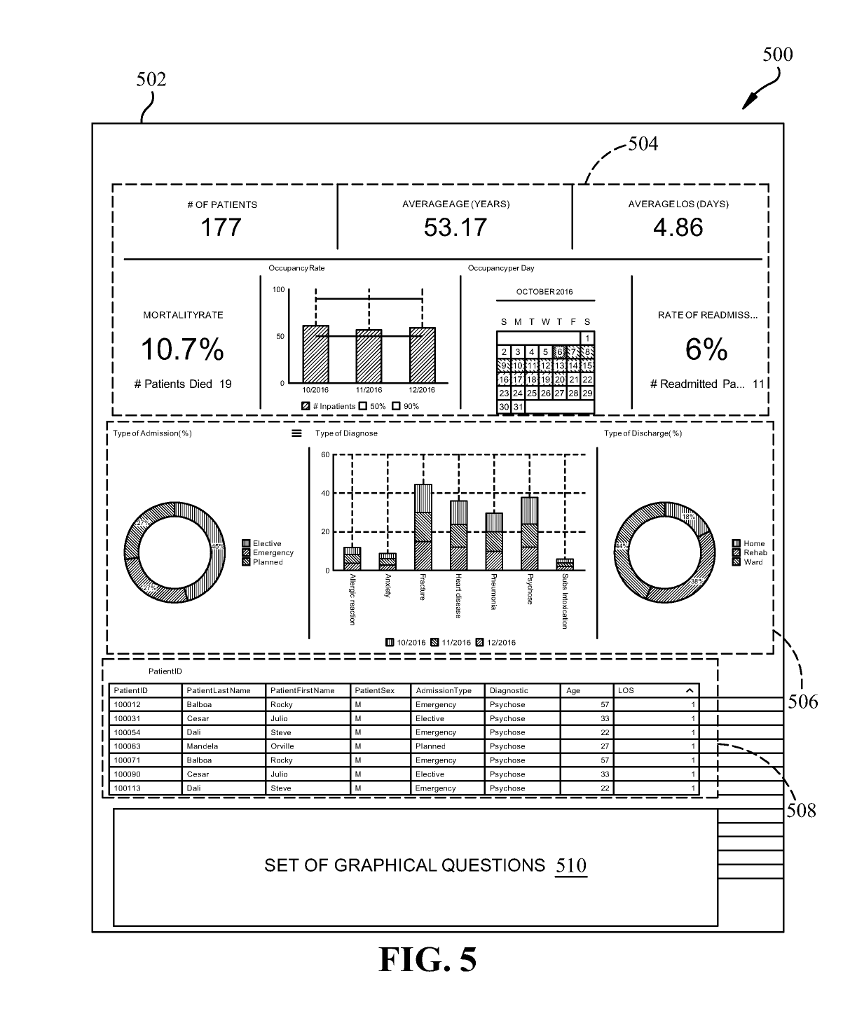

Referring to FIG. 5, there is illustrated a non-limiting implementation of a system 500, in accordance with various aspects and implementations of this disclosure. Repetitive description of like elements employed in other embodiments described herein is omitted for sake of brevity. The system 500 illustrates an example data visualization tool 502. The data visualization tool 502 can be a data visualization tool (e.g., data visualization tool 306) analyzed by the data analytics component 102. The data visualization tool can be, for example, a dashboard (e.g., a data intelligence dashboard). In an aspect, the data visualization tool 502 can be associated with a user interface (e.g., a graphical user interface). The data visualization tool 502 can be presented on a display of a user device such as, but not limited to, a computing device, a computer, a desktop computer, a laptop computer, a monitor device, a smart device, a smart phone, a mobile device, a handheld device, a tablet, a portable computing device or another type of user device associated with a display. In an aspect, the data visualization tool can allow a user to view, analyze and/or interact with data 508. For instance, the data visualization tool 502 can include a section 504 that provides metrics associated with the data 508, statistics associated with the data 508, and/or key performance indicators associated with the data 508. The data 508 can be generated by one or devices. Additionally or alternatively, the data 508 can be stored in one or more databases that receives and/or stores the data associated with the one or devices. For example, the data 508 can be generated by and/or associated with one or more assets, one or more types of devices, one or more types of machines and/or one or more types of equipment. Furthermore, the data 508 can include various data, such as but not limited to, medical data, medical imaging data, sensor data, process data (e.g., process log data), operational data, monitoring data, maintenance data, parameter data, measurement data, performance data, audio data, image data, video data, industrial data, machine data, asset data, equipment data, device data, meter data, real-time data, historical data and/or other data. The data can also be encoded data, processed data and/or raw data. In an embodiment, the data 508 can be data received by the data analytics component 102.

Additionally or alternatively, the data visualization tool 502 can include a section 506 that provides graphical metrics associated with the data 508, graphical statistics associated with the data 508, and/or graphical key performance indicators associated with the data 508. For example, the data visualization tool 502 can include one or more charts and/or one or more graphs generated based on the data 508. As such, the data 508 can be viewed via the data visualization tool 502 in a graphical human interpretable format. In another embodiment, the data visualization tool 502 can include a set of graphical questions 510. The set of graphical questions 510 can present a set of questions graphically. The set of graphical questions 510 can be a set of graphical questions associated with the data 508. Furthermore, the set of graphical questions 510 can be associated with a set of user interactions. The set of user interaction can be a set of user interactions to, for example, view, analyze and/or interact with the data 508 via the data visualization tool 502. The set of user interaction can also facilitate generation of one or more predictions targets for the data 508. In an embodiment, the prediction component 106 can generate the prediction target data based on analysis of the set of user interactions associated with the set of graphical questions 510. It is to be appreciated that the data visualization tool 502 is merely an example. Therefore, the location of sections associated with the data visualization tool 502 and/or content of the data visualization tool 502 can be varied. Furthermore, the data visualization tool 502 can include other features, content and/or functionalities not shown in FIG. 5.

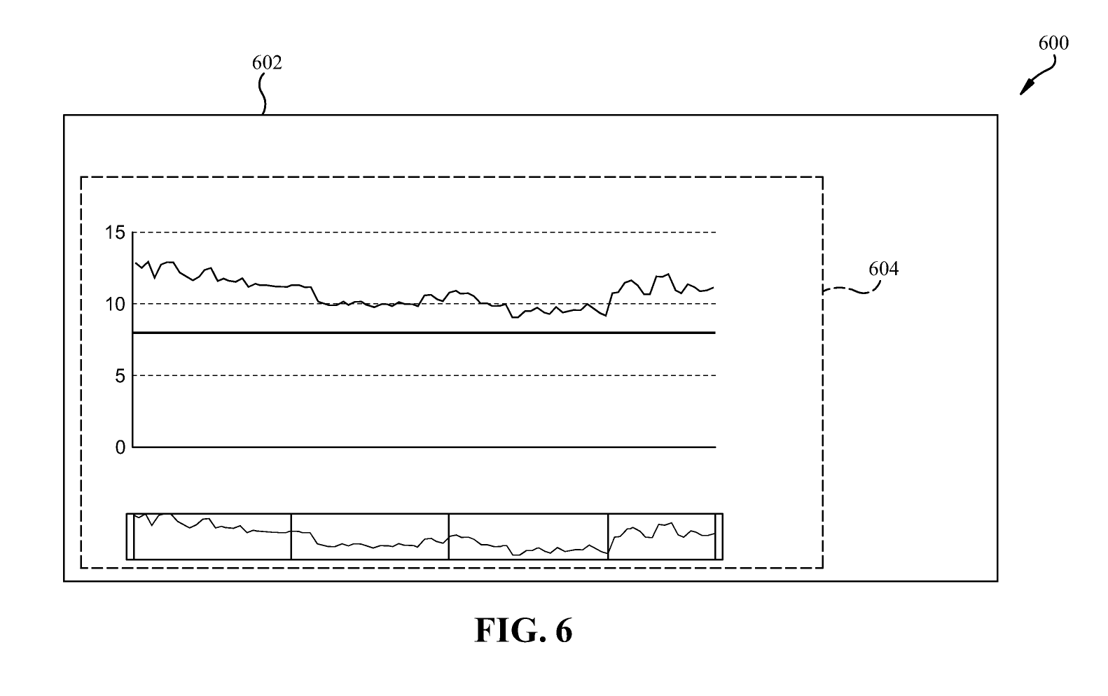

Referring to FIG. 6, there is illustrated a non-limiting implementation of a system 600, in accordance with various aspects and implementations of this disclosure. Repetitive description of like elements employed in other embodiments described herein is omitted for sake of brevity. The system 600 illustrates an example user interface 602. In one embodiment, the user interface 602 can be associated with a user interface generated by the display component 202. The user interface 602 can be a user interface (e.g., a graphical user interface) presented on a display of a user device such as, but not limited to, a computing device, a computer, a desktop computer, a laptop computer, a monitor device, a smart device, a smart phone, a mobile device, a handheld device, a tablet, a portable computing device or another type of user device associated with a display. In certain embodiments, the user interface 602 can be associated with a data visualization tool such as, for example, a dashboard (e.g., a data intelligence dashboard). The user interface 602 can include a section 604 that provides information associated with a machine learning process (e.g., machine learning process 312). For example, the section 604 can provide information associated with the machine learning model generated by the data analytics component 102. In an aspect, the section 604 can provide the information associated with the machine learning model in a graphical human interpretable format. For instance, the section 604 can provide the information associated with the machine learning model as graphical metrics associated with the machine learning model and/or graphical key performance indicators associated with the machine learning model. In another embodiment, the section 604 can provide the information associated with the machine learning model based on the data 508 associated with the data visualization tool 502 and/or the set of graphical questions 510 associated with the data visualization tool 502. It is to be appreciated that the user interface 602 is merely an example. Therefore, the location of sections associated with the user interface 602 and/or content of the user interface 602 can be varied. Furthermore, the user interface 602 can include other features, content and/or functionalities not shown in FIG. 6.

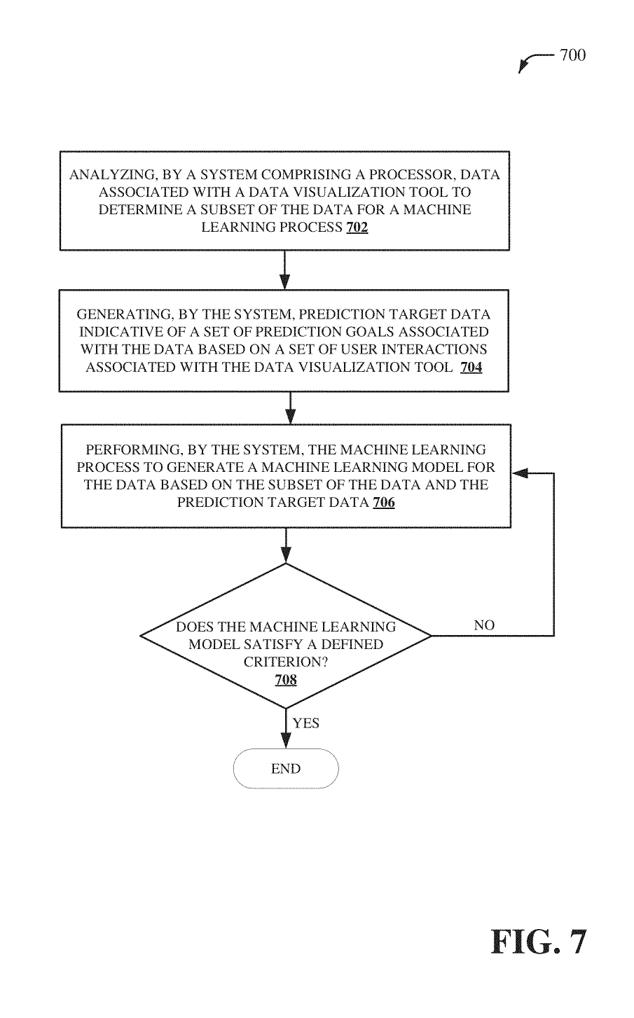

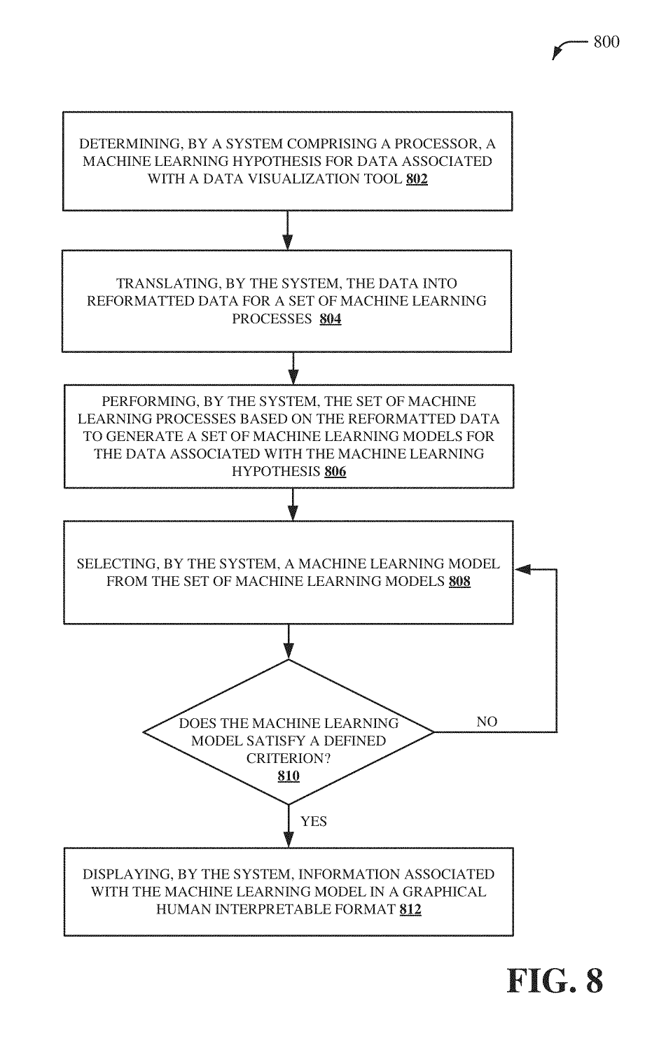

FIGS. 7-8 illustrate methodologies and/or flow diagrams in accordance with the disclosed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device or storage media.

Referring to FIG. 7, there is illustrated a non-limiting implementation of a methodology 700 for facilitating a data intelligence driven artificial intelligence model in accordance with one or more embodiments described herein. At 702, data associated with a data visualization tool is analyzed, by a system comprising a processor (e.g., by data intelligence component 104), to determine a subset of the data for a machine learning process. For example, a data scrubbing process associated with the data can be performed to determine the subset of the data. For example, the data scrubbing process can include decoding the data, filtering the data, processing the data, combining the data and/or translating the data. The data associated with the data visualization tool can be generated by one or devices. For example, the data associated with the data visualization tool can be generated by and/or associated with one or more assets, one or more types of devices, one or more types of machines and/or one or more types of equipment. In an aspect, the data associated with the data visualization tool can be digital data. Furthermore, the data associated with the data visualization tool can include various data, such as but not limited to, medical data, medical imaging data, sensor data, process data (e.g., process log data), operational data, monitoring data, maintenance data, parameter data, measurement data, performance data, audio data, image data, video data, industrial data, machine data, asset data, equipment data, device data, meter data, real-time data, historical data and/or other data. The data can also be encoded data, processed data and/or raw data. The data visualization tool can render the data in a human interpretable format on a display of a user device. The user device can be, for example, a computing device, a computer, a desktop computer, a laptop computer, a monitor device, a smart device, a smart phone, a mobile device, a handheld device, a tablet, a portable computing device or another type of user device associated with a display. In an aspect, the data visualization tool can be a user interface (e.g., a graphical user interface) associated with the user device. In another aspect, the data visualization tool can allow a user to view, analyze and/or interact with the data. In yet another aspect, the data visualization tool can be a dashboard (e.g., a data intelligence dashboard) that provides metrics associated with the data and/or key performance indicators associated with the data.

At 704, prediction target data indicative of a set of prediction goals associated with the data is generated, by the system (e.g., by prediction component 106), based on a set of user interactions associated with the data visualization tool. The set of user interaction can be a set of user interactions to, for example, view, analyze and/or interact with the data via the data visualization tool. In an aspect, the set of user interaction can be a set of workflows to dynamically create the prediction target data. In an embodiment, the prediction target data can be generated based on a set of graphical questions associated with the data visualization tool. For instance, the data visualization tool can present a set of questions graphically and the prediction target data can be generated based on analysis of a set of user interactions associated with the set of questions.

At 706, the machine learning process is performed, by the system (e.g., by machine learning component 108), to generate a machine learning model for the data based on the subset of the data and the prediction target data. The machine learning process can, for example, perform deep learning to facilitate one or more classifications, one or more inferences and/or one or more predictions associated with the data. For instance, the machine learning process can extract information that is indicative of correlations, inferences and/or expressions from the subset of the data and/or the prediction target data. The machine learning model can include, for example, learning, correlations, inferences and/or expressions associated with the data. The machine learning process can additionally or alternatively employ any suitable machine-learning based techniques, statistical-based techniques and/or probabilistic-based techniques. For example, the machine learning process can employ expert systems, fuzzy logic, SVMs, Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, etc.

In certain embodiments, the performing the machine learning process can include performing a first machine learning process to generate a first machine learning model and performing a second machine learning process to generate a second machine learning model. Furthermore, in certain embodiments, the methodology 700 can include selecting, by the system, the first machine learning model or the second machine learning model based on the prediction target data. In certain embodiments, the methodology 700 can include reformatting, by the system, the subset of the data into reformatted data associated with a multi-dimensional database. Additionally, in certain embodiments, the methodology 700 can include providing, by the system, the reformatted data to the machine learning process. In certain embodiments, the methodology 700 can include providing, by the system, the subset of the data to a multi-dimensional database to reformat the data into reformatted data. In certain embodiments, the methodology 700 can include generating, by the system, a user interface that outputs the machine learning model in a graphical human interpretable format.

At 708, it is determined whether the machine learning model satisfies a defined criterion. For example, it can be determined whether the machine learning model satisfies a defined criterion associated with the prediction target data. If no, the methodology 700 returns to 706. If yes, the methodology 700 ends.

Referring to FIG. 8, there is illustrated a non-limiting implementation of a methodology 800 for facilitating a data intelligence driven artificial intelligence model in accordance with one or more embodiments described herein. At 802, a machine learning hypothesis for data associated with a data visualization tool is determined by a system comprising a processor (e.g., by data intelligence component 104). The machine learning hypotheses can be a prediction target or a rule for a function to model. In an embodiment, the machine learning hypothesis can be generated based on a set of user interactions associated with the data visualization tool. The set of user interaction can be a set of user interactions to, for example, view, analyze and/or interact with the data via the data visualization tool. In an aspect, the set of user interaction can be a set of workflows to dynamically create the machine learning hypothesis. In an embodiment, the machine learning hypothesis can be generated based on a set of graphical questions associated with the data visualization tool. For instance, the data visualization tool can present a set of questions graphically and the machine learning hypothesis can be generated based on analysis of a set of user interactions associated with the set of questions.

At 804, the data is translated, by the system (e.g., by the data intelligence component 104) into reformatted data for a set of machine learning processes. In an embodiment, the data can be translated via a multi-dimensional database. The multi-dimensional database can translate the data into a multi-dimensional format. For instance, multi-dimensional database can translate the data into a multi-dimensional array of data where data is categorized based on dimensions. In one example, the multi-dimensional database can be an online analytical processing cube.

At 806, the set of machine learning processes is performed, by the system (e.g., by machine learning component 108), based on the reformatted data to generate a set of machine learning models for the data associated with the machine learning hypothesis. The set of machine learning processes can, for example, perform different machine learning processes associated with deep learning to facilitate two or more classifications, two or more inferences and/or two or more predictions associated with the reformatted data. For instance, the set of machine learning processes can extract various information that is indicative of various correlations, various inferences and/or various expressions from the reformatted data. The machine learning model can include, for example, learning, correlations, inferences and/or expressions associated with the data. The set of machine learning processes can additionally or alternatively employ multiple machine-learning based techniques, statistical-based techniques and/or probabilistic-based techniques. For example, the set of machine learning processes can employ expert systems, fuzzy logic, SVMs, Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or other machine learning systems.

At 808, a machine learning model from the set of machine learning models is selected by the system (e.g., by machine learning component 108). At 810, it is determined whether the machine learning model satisfies a defined criterion. For example, it can be determined whether the machine learning model satisfies a defined criterion associated with the prediction target data. If no, the methodology 800 returns to 808. If yes, the methodology 800 proceed to 812.

At 812, information associated with the machine learning model is displayed, by the system (e.g., by display component 202), in a graphical human interpretable format. For instance, a user interface (e.g., a graphical user interface) that outputs the machine learning model in a graphical human interpretable format can be rendered on a display. The user interface can be displayed, for example, on a display of a user device such as a computing device, a computer, a desktop computer, a laptop computer, a monitor device, a smart device, a smart phone, a mobile device, a handheld device, a tablet, a portable computing device or another type of user device associated with a display. In an aspect, the information associated with the machine learning model can include metrics and/or key performance indicators related to the machine learning model and/or information associated with the machine learning model. In an embodiment, the machine learning model and/or information associated with the machine learning model can be displayed via a data visualization tool.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

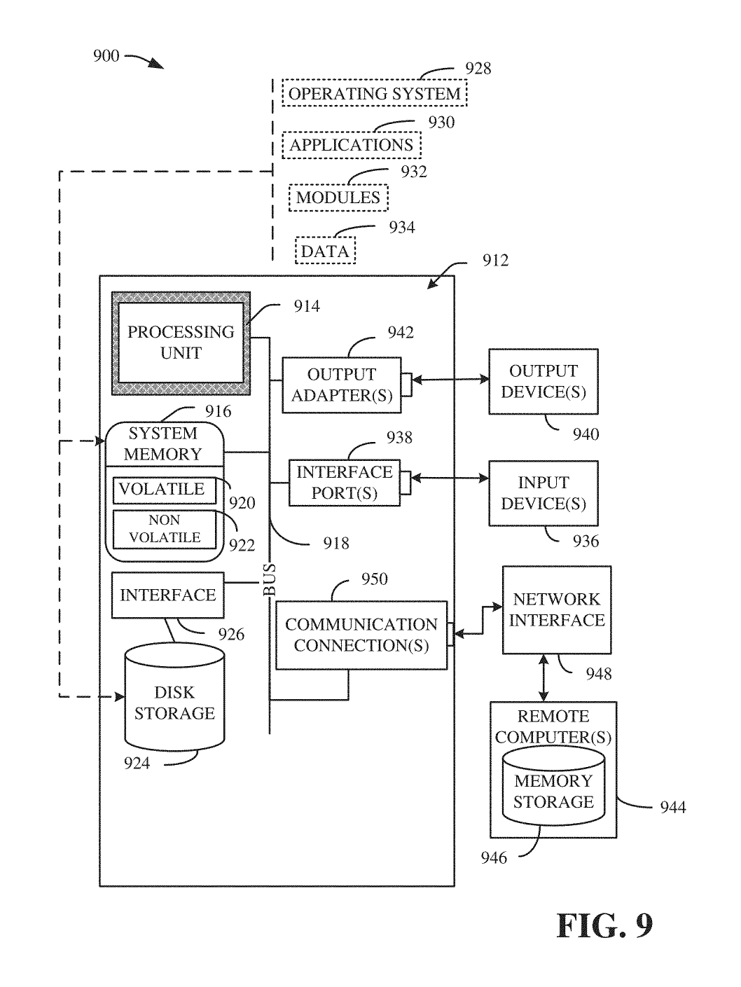

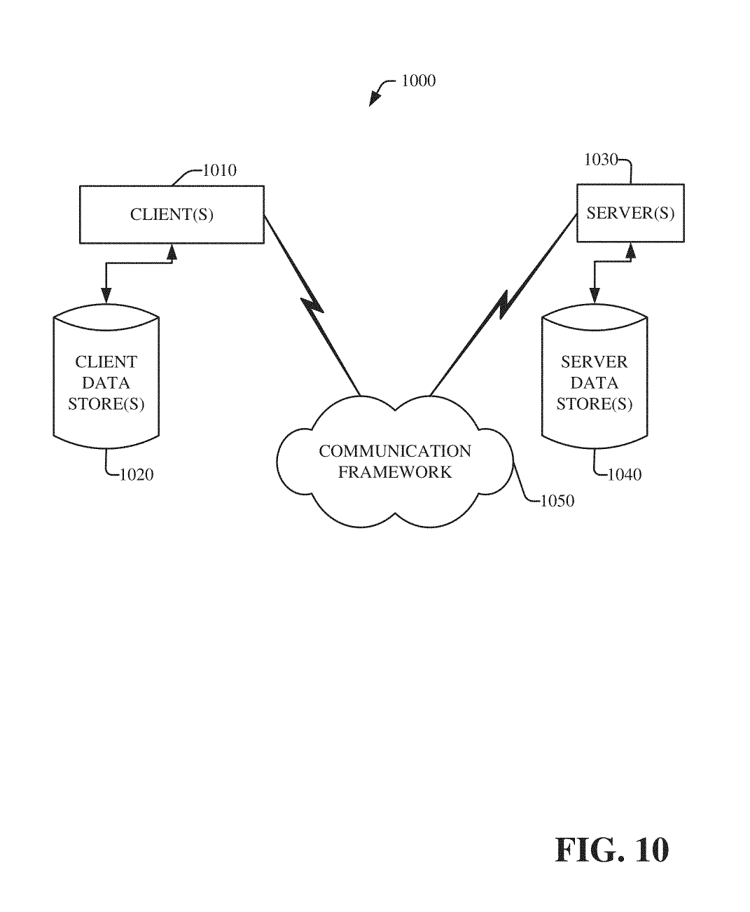

In order to provide a context for the various aspects of the disclosed subject matter, FIGS. 9 and 10 as well as the following discussion are intended to provide a brief, general description of a suitable environment in which the various aspects of the disclosed subject matter may be implemented.

With reference to FIG. 9, a suitable environment 900 for implementing various aspects of this disclosure includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 920 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 912 also includes removable/non-removable, volatile/non-volatile computer storage media. FIG. 9 illustrates, for example, a disk storage 924. Disk storage 924 includes, but is not limited to, devices like a magnetic disk drive, floppy disk drive, tape drive, Jaz drive, Zip drive, LS-100 drive, flash memory card, or memory stick. The disk storage 924 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used, such as interface 926.

FIG. 9 also depicts software that acts as an intermediary between users and the basic computer resources described in the suitable operating environment 900. Such software includes, for example, an operating system 928. Operating system 928, which can be stored on disk storage 924, acts to control and allocate resources of the computer system 912. System applications 930 take advantage of the management of resources by operating system 928 through program modules 932 and program data 934, e.g., stored either in system memory 916 or on disk storage 924. It is to be appreciated that this disclosure can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940, which require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 with which the subject matter of this disclosure can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing this disclosure, for example. One possible communication between a client 1010 and a server 1030 may be in the form of a data packet transmitted between two or more computer processes.

The system 1000 includes a communication framework 1050 that can be employed to facilitate communications between the client(s) 1010 and the server(s) 1030. The client(s) 1010 are operatively connected to one or more client data store(s) 1020 that can be employed to store information local to the client(s) 1010. Similarly, the server(s) 1030 are operatively connected to one or more server data store(s) 1040 that can be employed to store information local to the servers 1030.

It is to be noted that aspects or features of this disclosure can be exploited in substantially any wireless telecommunication or radio technology, e.g., Wi-Fi; Bluetooth; Worldwide Interoperability for Microwave Access (WiMAX);

Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as internet protocol television (IPTV), etc.) can exploit aspects or features described herein.

While the subject matter has been described above in the general context of computer-executable instructions of a computer program that runs on a computer and/or computers, those skilled in the art will recognize that this disclosure also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of this disclosure can be practiced on stand-alone computers. In a distributed computing environment, program modules may be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

Various aspects or features described herein can be implemented as a method, apparatus, system, or article of manufacture using standard programming or engineering techniques. In addition, various aspects or features disclosed in this disclosure can be realized through program modules that implement at least one or more of the methods disclosed herein, the program modules being stored in a memory and executed by at least a processor. Other combinations of hardware and software or hardware and firmware can enable or implement aspects described herein, including a disclosed method(s). The term “article of manufacture” as used herein can encompass a computer program accessible from any computer-readable device, carrier, or storage media. For example, computer readable storage media can include but are not limited to magnetic storage devices (e.g., hard disk, floppy disk, magnetic strips . . . ), optical discs (e.g., compact disc (CD), digital versatile disc (DVD), blu-ray disc (BD) . . . ), smart cards, and flash memory devices (e.g., card, stick, key drive . . . ), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or methods herein are intended to include, without being limited to including, these and any other suitable types of memory.

It is to be appreciated and understood that components, as described with regard to a particular system or method, can include the same or similar functionality as respective components (e.g., respectively named components or similarly named components) as described with regard to other systems or methods disclosed herein.

What has been described above includes examples of systems and methods that provide advantages of this disclosure. It is, of course, not possible to describe every conceivable combination of components or methods for purposes of describing this disclosure, but one of ordinary skill in the art may recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A machine learning system, comprising:
a memory that stores computer executable components;
a processor that executes computer executable components stored in the memory, wherein the computer executable components comprise:
a data intelligence component that analyzes data associated with a data visualization tool to determine a subset of the data to model;
a prediction component that generates prediction target data indicative of a set of prediction goals associated with the data based on a set of user interactions associated with the data visualization tool; and
an machine learning component that generates a machine learning model for the data based on the subset of the data and the prediction target data.

2. The machine learning system of claim 1, wherein the data intelligence component reformats the subset of the data into reformatted data and provides the reformatted data to a machine learning process associated with the machine learning component.

3. The machine learning system of claim 1, wherein the data intelligence component provides the subset of the data to a multi-dimensional database.

4. The machine learning system of claim 2, wherein the machine learning process is a first machine learning process, and wherein the data intelligence component provides the reformatted data to the first machine learning process and a second machine learning process that is executed in parallel to the first machine learning process.

5. The machine learning system of claim 4, wherein the machine learning component selects a first machine learning model associated with the first machine learning process or a second machine learning model associated with the second machine learning process based on the prediction target data.

6. The machine learning system of claim 1, wherein the prediction component generates the prediction target data based on a set of graphical questions associated with the data visualization tool.

7. The machine learning system of claim 1, wherein the computer executable components further comprise:
a display component that generates a user interface, for display, that outputs the machine learning model in a graphical human interpretable format.

8. A method, comprising:
analyzing, by a system comprising a processor, data associated with a data visualization tool to determine a subset of the data for a machine learning process;
generating, by the system, prediction target data indicative of a set of prediction goals associated with the data based on a set of user interactions associated with the data visualization tool; and
performing, by the system, the machine learning process to generate a machine learning model for the data based on the subset of the data and the prediction target data.

9. The method of claim 8, wherein the method further comprises:
reformatting, by the system, the subset of the data into reformatted data associated with a multi-dimensional database.

10. The method of claim 9, wherein the method further comprises:
providing, by the system, the reformatted data to the machine learning process.

11. The method of claim 8, wherein the method further comprises:
providing, by the system, the subset of the data to a multi-dimensional database.

12. The method of claim 8, wherein the generating the prediction target data comprises generating the prediction target data based on a set of graphical questions associated with the data visualization tool.

13. The method of claim 8, wherein the performing the machine learning process comprises performing a first machine learning process to generate a first machine learning model and performing a second machine learning process to generate a second machine learning model.

14. The method of claim 13, wherein the method further comprises:
selecting, by the system, the first machine learning model or the second machine learning model based on the prediction target data.

15. The method of claim 8, wherein the method further comprises:
generating, by the system, a user interface that outputs the machine learning model in a graphical human interpretable format.

16. A computer readable storage device comprising instructions that, in response to execution, cause a system comprising a processor to perform operations, comprising:
analyzing data associated with a data visualization tool to determine a subset of the data to model;
generating prediction target data indicative of a set of prediction goals associated with the data based on a set of user interactions associated with the data visualization tool;
generating a machine learning model for the data based on the subset of the data and the prediction target data; and
displaying the machine learning model in a graphical human interpretable format.

17. The computer readable storage device of claim 16, wherein the operations further comprise:
transforming the subset of the data via a multi-dimensional database.

18. The computer readable storage device of claim 16, wherein the operations further comprise:
providing the subset of the data to a first machine learning process and a second machine learning process that is executed in parallel to the first machine learning process.

19. The computer readable storage device of claim 18, wherein the operations further comprise:
selecting a first machine learning model associated with the first machine learning process or a second machine learning model associated with the second machine learning process based on the prediction target data.

20. The computer readable storage device of claim 16, wherein the operations further comprise:
generating the prediction target data based on a set of graphical questions associated with the data visualization tool.
